(19) United States
(12) Patent Application Publication
(10) Pub. No.: US 2002/0041952 A1
(43) Pub. Date: Apr. 11, 2002

(54) Aqueous nanoparticle ceramic agglomerate dispersion for forming ink-absorbing layer of ink-jet recording medium

(76) Inventors: Masamichi Murota, Yokkaichi City (JP); Hirokuni Shirono, Yokkaichi City (JP); Masahide Arai, Chofu City (JP)

Correspondence Address: SMITH, GAMBRELL & RUSSELL, LLP, ATTORNEY AT LAW, 1850 M STREET, N.W., SUITE 800, WASHINGTON, DC, 20036, US

(21) Appl. No.: 09/893,513

(22) Filed: Jun. 29, 2001

(30) Foreign Application Priority Data
Jul. 3, 2000 (JP) 2000-200794

(51) Int. Cl. C04B 35/10; C04B 35/14

(52) U.S. Cl. 428/195; 501/153; 501/154

(57) ABSTRACT

An aqueous nanoparticle ceramic agglomerate dispersion, for forming an ink-absorbing layer of an ink-jet recording medium, containing a nanoparticle ceramic agglomerate dispersed in deionized water. The nanoparticle ceramic agglomerate has an average diameter of 0.05 to 0.3 μm at a viscosity suitable for coating of 10 to 200 mpa.s as measured by a laser diffraction particle size distribution measurement apparatus, and the ratio of the peak width (half width) at a height which is half the maximum height in a size distribution curve of the nanoparticle ceramic agglomerate, determined according to the results of the measurement, to the maximum height is 0.7 or less. This aqueous ceramic dispersion provides an ink-jet recording medium which enables the printing of sharp and clear images.

The present invention relates to an aqueous nanoparticle ceramic agglomerate dispersion which is suitable for ink-absorbing layers on ink-jet recording media and which facilitates printing of sharp and clear images on the ink-jet recording media.

### DESCRIPTION OF THE RELATED ART

A typical conventional ink-jet recording medium includes a substrate having a thickness of 100 to 300 μm, such as paper or a polyethylene film, an ink-absorbing layer having a thickness of 30 to 200 μm formed thereon by coating, and a protective layer having a thickness of 1 to 10 μm composed of a water-soluble resin or the like, which is formed on the ink-absorbing layer by spraying.

In general, the ink-absorbing layer of the ink-jet recording medium is formed as follows. Nanoparticle ceramic agglomerates, such as a powdered silicon oxide (hereinafter referred to as SiO₂) agglomerate and a powdered aluminum oxide (hereinafter referred to as Al₂O₃) agglomerate are added to deionized water to form an aqueous nanoparticle ceramic agglomerate dispersion so that the dispersion has a viscosity suitable for coating of 10 to 200 mpa.s. To the dispersion, for example, a cationic polymer, ethanol, propanol, ethyl acetate, polyvinyl alcohol, and boric acid are added to prepare a coating. The coating is applied onto the substrate surface and is dried.

The above raw materials used for the aqueous nanoparticle ceramic agglomerate dispersion are generally prepared by a vapor phase synthetic method using SiCl₄ and AlCl₃ in the presence of hydrogen and oxygen, for example, from a burner. The resulting nanoparticle ceramic powder has an extremely small average diameter of 7 to 40 nm. Thus, ceramic particles inevitably interact with each other and readily agglomerate. Even when this nanoparticle ceramic powder is added to deionized water after disintegration in a ball mill, the nanoparticle ceramic powder is present as a ceramic powder agglomerate having an average diameter of 1 to 30 μm.

In the printing of images onto the ink-jet recording medium, fine ink droplets discharged through dot nozzles of an ink-jet printer are absorbed into the ink-absorbing layer. In color printing, such a process is repeated several times using inks of different colors.

With trends toward higher performance in ink-jet printers, the size of the ink droplets discharged from the ink-jet printers has been reduced to 20 μm or less. When this ink is discharged onto the above conventional ink-jet recording medium, the ink droplets flow locally in the ink-absorbing layer and result in bleeding. As a result, printed images are not clear, regardless of how ultrafine the ink droplets are.

### SUMMARY OF THE INVENTION

It is an object of the present invention to provide an aqueous nanoparticle ceramic agglomerate dispersion which is suitable for ink-absorbing layers on ink-jet recording media and which facilitates printing of sharp and clear images onto the ink-jet recording media.

The present inventors have researched aqueous nanoparticle ceramic agglomerate dispersions for ink-absorbing layers so that the ink-absorbing layer can hold ultrafine ink droplets discharged from an ink-jet printer at the discharged positions, and have reached the following conclusions.

a) In a conventional aqueous nanoparticle ceramic agglomerate dispersion, the nanoparticle ceramic agglomerate has an average diameter of 1 to 30 μm according to measurements by a laser diffraction particle size distribution measurement apparatus. The size distribution curve determined according to the results of the measurement is shown in FIG. 2. The ratio of the peak width at a position having a height which is half the maximum height of the curve (hereinafter referred to as the half width) to the maximum height is 1 to 1.5. Such a ratio indicates that the nanoparticle ceramic agglomerate is relatively rough and sizes thereof are not uniform. That is, the size uniformity of the agglomerates is inadequate. In an auxiliary insulating layer containing such nanoparticle ceramic agglomerates having a broad size distribution, larger agglomerates on the ink-absorbing layer absorb many ultrafine ink droplets. That is, the ultrafine ink droplets cannot be held at discharged positions, and bleed from the discharged positions.

b) The above conventional aqueous nanoparticle ceramic agglomerate dispersion is generally prepared by dispersing 1 to 50% of nanoparticle ceramic agglomerate into deionized water using a conventional mixer. When this dispersion is treated using a conventional ultrasonic homogenizer for a predetermined time, or using a jet-mill apparatus for a predetermined time in which ultrahigh-pressure counter jet streams of the dispersion collide with each other, the nanoparticle ceramic agglomerates are rapidly disintegrated in the aqueous medium. When the nanoparticle ceramic agglomerate satisfies the following conditions by controlling the treatment time, the resulting nanoparticle ceramic agglomerates in the dispersion have a relatively small and uniform size, an ink-absorbing layer containing this aqueous nanoparticle ceramic agglomerate dispersion can hold fine ink droplets at discharged positions, without bleeding, and an image printed on an ink-jet recording medium is significantly sharp and clear. That is, the conditions are:

The average diameter of the nanoparticle ceramic agglomerate dispersed in deionized water is 0.05 to 0.3 μm according to measurements at a viscosity suitable for coating of 10 to 200 mpa.s using a laser diffraction particle size distribution measurement apparatus, and the ratio of the peak width (half width) at a position having a height which is half the maximum height of a curve shown in FIG. 2 of the particle size distribution determined according to the results of the measurement to the maximum height is 0.7 or less.

Accordingly an aqueous nanoparticle ceramic agglomerate dispersion in accordance with the present invention, for forming an ink-absorbing layer of an ink-jet recording medium, comprises a nanoparticle ceramic agglomerate dispersed in deionized water, wherein the nanoparticle ceramic agglomerate has an average diameter of 0.05 to 0.3 μm at a viscosity suitable for coating of 10 to 200 mpa.s as measured by a laser diffraction particle size distribution measurement apparatus, and the ratio of the peak width at a height which is half the maximum height in a size distribution curve of the nanoparticle ceramic agglomerate, determined according to the results of the measurement, to the maximum height is 0.7 or less.

### BRIEF DESCRIPTION OF THE DRAWINGS

FIG. 1 is a size distribution curve of ceramic agglomerates in an aqueous nanoparticle ceramic agglomerate dispersion in accordance with the present invention; and

FIG. 2 is a size distribution curve of ceramic agglomerates in a conventional nanoparticle ceramic agglomerate dispersion.

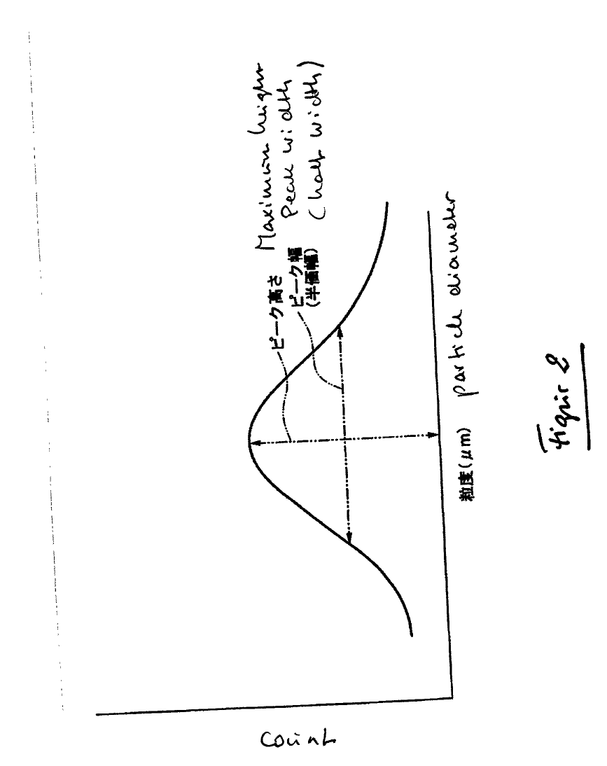

### DESCRIPTION OF THE PREFERRED EMBODIMENTS

In the present invention, the average diameter of the nanoparticle ceramic agglomerate is in a range of 0.05 to 0.3 μm. At an average diameter less than 0.05 μm, there are no longer distinct differences in the quality of printed images. At a diameter exceeding 0.3 μm, some fine ink droplets of different colors having diameters of 20 μm or less are absorbed in the same nanoparticle ceramic agglomerate, resulting in ink bleeding. Thus, the resulting images are not clear.

The ratio of the half width in the size distribution curve of the nanoparticle ceramic agglomerate to the maximum height is in a range of 0.7 or less. At a half width exceeding 0.7, many ceramic agglomerates having diameters which significantly deviate from the average diameter are present. When an ink-absorbing layer contains these ceramic agglomerates, each of the relatively large agglomerates will absorb different types of color inks, resulting in ink bleeding. As a result, the printed image exhibits color irregularities.

The viscosity suitable for coating of the aqueous nanoparticle ceramic agglomerate dispersion is in a range of 10 to 200 mpa.s. At a viscosity of less than 10 mPa.s, the dispersion is not held on the substrate. At a viscosity exceeding 200 mPa.s, the dispersion cannot be uniformly applied on the substrate.

The aqueous nanoparticle ceramic agglomerate dispersion in accordance with the present invention will now be described with reference to the following Examples.

Using SiCl₄, AlCl₃, or TiCl₄ as raw materials, nanoparticle SiO₂ powder, nanoparticle Al₂O₃ powder, and nanoparticle TiO₂ powder, each having a number average primary particle diameter (hereinafter termed average particle diameter) shown in Table 1, were prepared by gas-phase hydrolysis in a burner containing hydrogen and oxygen. Since these nanoparticle ceramic powders were present as agglomerates, they were disintegrated in a conventional dry disintegrator for a predetermined time, and were added to deionized water in a bead mill while stirring to prepare conventional aqueous nanoparticle ceramic agglomerate dispersions (hereinafter termed aqueous ceramic dispersion) 1 to 15, each having a viscosity shown in Table 1.

Each of these aqueous nanoparticle ceramic agglomerate dispersions 1 to 15 was treated in a jet-mill apparatus in which counter jet streams of the dispersion collided with each other at a jet-stream radius of 0.1 mm at the collision position, a jet-stream velocity of 600 m/sec and a flow rate of the jet streams at the nozzles of 15 liter/min. for a predetermined time to disintegrate the nanoparticle ceramic agglomerates. In this manner, aqueous nanoparticle ceramic agglomerate dispersions 1 to 15 in accordance with the present invention (hereinafter termed aqueous ceramic dispersions of the present invention) were prepared.

After the conventional aqueous ceramic dispersions 1 to 15 and the aqueous ceramic dispersions 1 to 15 of the present invention were maintained at 22° C. for 2 hours, the viscosity of each dispersion was measured at 2.5 rpm using an E-type viscometer (made by Toki Sangyo K.K.). The particle size distribution of the nanoparticle ceramic agglomerate in the dispersion was measured using a laser diffraction particle size distribution measurement apparatus, and the average agglomerate diameter was calculated according to the results. Moreover, a size distribution curve was prepared to determine the ratio of the half width (the width at a position having a height which was half the maximum height of the curve) to the maximum height. These results are shown in Table 1.

To 1000 ml of each dispersion was added 10 to 40 g of cationic polymer, 50 to 100 ml of ethanol, 15 to 30 ml of propanol, 10 to 20 ml of ethyl acetate, 20 to 50 g of polyvinyl alcohol, and 1 to 10 g of boric acid to prepare a coating for forming an ink-absorbing layer. The coating was applied onto a recording surface of water-absorbing paper having a thickness of 200 μm, was rapidly cooled, and was dried by hot air at 50° C. for 3 minutes. An ink-jet recording medium having an 80-μm thick ink-absorbing layer was thereby prepared.

Yellow, magenta, and cyan solid images were printed onto the ink-jet recording medium using an ink-jet color printer PM-3300C made by Seiko Epson Corporation, and reflection densities were measured for monochromatic light of red, green, and blue. The results are shown in Table 2.

A color image of a person having a size of 250×180 mm was printed on the ink-jet recording medium and the image quality was observed at a magnification of 3000 using a high-precision digital microscope.

TABLE 1

| | Average | | | | | |
|---|---|---|---|---|---|---|
| | Particle | | | | | |
| | Diameter | Nonoparticle Ceramic Agglomerate | | | | |
| | of Raw | | Concen- | | Average | |
| | Material | | tration | Viscosity | Diameter | |
| Type | (nm) | Material | (%) | (mPa · s) | (μm) | Ratio |
| Aqueous | | | | | | |
| Ceramic | | | | | | |
| Dispersion | | | | | | |
| of Present | | | | | | |
| Invention | | | | | | |
| 1 | 40 | SiO₂ | 5 | 10 | 0.06 | 0.51 |
| 2 | 7 | SiO₂ | 30 | 30 | 0.08 | 0.55 |
| 3 | 12 | SiO₂ | 30 | 50 | 0.10 | 0.60 |
| 4 | 30 | SiO₂ | 50 | 100 | 0.20 | 0.62 |
| 5 | 7 | SiO₂ | 50 | 200 | 0.29 | 0.65 |
| 6 | 13 | Ai₂O₃ | 5 | 10 | 0.07 | 0.55 |
| 7 | 13 | Ai₂O₃ | 20 | 30 | 0.09 | 0.57 |
| 8 | 13 | Ai₂O₃ | 30 | 50 | 0.16 | 0.58 |
| 9 | 10 | Ai₂O₃ | 40 | 100 | 0.20 | 0.61 |
| 10 | 10 | Ai₂O₃ | 50 | 200 | 0.25 | 0.63 |
| 11 | 39 | TiO₂ | 5 | 10 | 0.05 | 0.48 |
| 12 | 21 | TiO₂ | 20 | 30 | 0.10 | 0.58 |
| 13 | 13 | TiO₂ | 25 | 50 | 0.16 | 0.60 |
| 14 | 21 | TiO₂ | 35 | 100 | 0.21 | 0.62 |
| 15 | 13 | TiO₂ | 50 | 200 | 0.30 | 0.66 |
| Conven- | | | | | | |
| tional | | | | | | |
| Aqueous | | | | | | |
| Ceramic | | | | | | |
| Dispersion | | | | | | |
| 1 | 40 | SiO₂ | 5 | 33 | 1.50 | 1.10 |
| 2 | 7 | SiO₂ | 30 | 95 | 3.04 | 1.02 |
| 3 | 12 | SiO₂ | 30 | 181 | 5.20 | 1.15 |
| 4 | 30 | SiO₂ | 50 | 335 | 10.32 | 1.32 |
| 5 | 7 | SiO₂ | 50 | 841 | 20.45 | 1.48 |
| 6 | 13 | Ai₂O₃ | 5 | 37 | 2.02 | 1.02 |
| 7 | 13 | Ai₂O₃ | 20 | 97 | 5.00 | 1.11 |
| 8 | 13 | Ai₂O₃ | 30 | 169 | 10.03 | 1.15 |
| 9 | 10 | Ai₂O₃ | 40 | 388 | 19.12 | 1.24 |
| 10 | 10 | Ai₂O₃ | 50 | 765 | 29.28 | 1.44 |
| 11 | 39 | TiO₂ | 5 | 30 | 1.09 | 1.01 |
| 12 | 21 | TiO₂ | 20 | 79 | 3.00 | 1.10 |
| 13 | 13 | TiO₂ | 25 | 221 | 10.52 | 1.22 |
| 14 | 21 | TiO₂ | 35 | 398 | 15.06 | 1.31 |
| 15 | 13 | TiO₂ | 50 | 820 | 23.04 | 1.35 |

TABLE 2

| | Image Density | | |
|---|---|---|---|
| Type | Yellow | Magenta | Cyan |
| Aqueous | | | |
| Ceramic | | | |
| Dispersion | | | |
| of Present | | | |
| Invention | | | |
| 1 | 2.1 | 2.1 | 2.2 |
| 2 | 2.0 | 2.1 | 2.2 |
| 3 | 2.1 | 2.1 | 2.2 |
| 4 | 2.2 | 2.2 | 2.2 |
| 5 | 2.0 | 2.2 | 2.3 |
| 6 | 1.9 | 2.0 | 2.0 |
| 7 | 1.8 | 1.9 | 1.9 |
| 8 | 1.8 | 1.9 | 2.0 |
| 9 | 1.7 | 1.8 | 1.8 |
| 10 | 1.8 | 1.8 | 1.7 |
| 11 | 1.7 | 1.9 | 1.8 |
| 12 | 1.7 | 1.8 | 1.9 |
| 13 | 1.8 | 1.8 | 1.8 |
| 14 | 1.8 | 1.8 | 1.7 |
| 15 | 1.8 | 1.7 | 1.6 |
| Conventional | | | |
| Aqueous | | | |
| Ceramic | | | |
| Dispersion | | | |
| 1 | 1.6 | 1.8 | 1.9 |
| 2 | 1.5 | 1.8 | 1.8 |
| 3 | 1.4 | 1.7 | 1.8 |
| 4 | 1.8 | 1.8 | 1.8 |
| 5 | 1.7 | 1.7 | 1.7 |
| 6 | 1.6 | 1.7 | 1.7 |
| 7 | 1.6 | 1.6 | 1.6 |
| 8 | 1.5 | 1.7 | 1.7 |
| 9 | 1.5 | 1.7 | 1.7 |
| 10 | 1.5 | 1.6 | 1.6 |
| 11 | 1.6 | 1.7 | 1.7 |
| 12 | 1.7 | 1.7 | 1.8 |
| 13 | 1.6 | 1.6 | 1.6 |
| 14 | 1.5 | 1.6 | 1.5 |
| 15 | 1.4 | 1.6 | 1.5 |

The results in Table 1 demonstrate that the diameters of the agglomerates of the aqueous ceramic dispersions 1 to 15 in accordance with the present invention are smaller and more uniform than those of the conventional aqueous ceramic dispersions 1 to 15. Since the ink-absorbing layer formed of one of the aqueous ceramic dispersions 1 to 15 in accordance with the present invention contains relatively fine and uniform agglomerates, ink droplets discharged from the ink-jet printer are precisely maintained at the discharged positions. Thus, the images printed on the ink-jet recording medium have a high density and are significantly clearer.

Accordingly, the aqueous nanoparticle ceramic agglomerate dispersion in accordance with the present invention can provide an ink-jet recording medium which contributes to improvements in performance of ink-jet printers.

Further variations and modifications of the foregoing will be apparent to those skilled in the art and are intended to be encompassed by the claims appended hereto. Japanese patent application 2000-200794 of Jul. 3, 2000 is relied on and incorporated herein by reference.

What is claimed is:

1. An aqueous nanoparticle ceramic agglomerate dispersion, for forming an ink-absorbing layer of an ink-jet recording medium, comprising:
a nanoparticle ceramic agglomerate dispersed in deionized water;
said nanoparticle ceramic agglomerate having an average diameter of 0.05 to 0.3 μm at a viscosity suitable for coating of 10 to 200 mpa.s as measured by a laser diffraction particle size distribution measurement apparatus, and
said nanoparticle ceramic agglomerate having a size distribution curve such that the ratio of peak width at a height which is half the maximum height of said curve, determined according to the results of said measurement, to the maximum height is 0.7 or less.

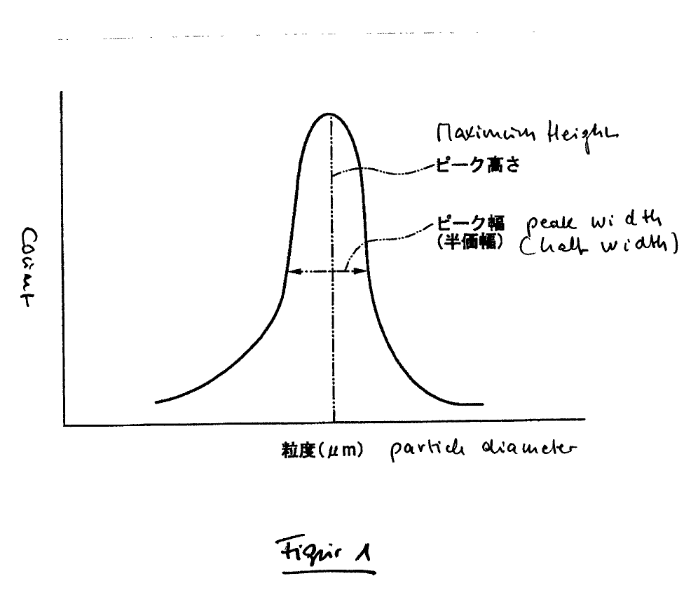

2. The aqueous nanoparticle ceramic agglomerate dispersion having a size distribution curve corresponding to FIG. 1.

3. An ink-jet recording medium having an ink-absorbing layer deposited on a surface thereof produced from the aqueous nanoparticle ceramic agglomerate dispersion of claim 1.

4. The ink-jet recording medium having an ink-absorbing layer deposited on a surface thereof produced from the aqueous nanoparticle ceramic agglomerate dispersion of claim 2.

5.The ink-jet recording medium according to claim 3 wherein said dispersion further contains a cationic polymer.

6. The ink-jet recording medium according to claim 3 wherein said surface is a water absorbing paper recording surface.

7. A method of making an ink jet recording medium comprising applying to a recording surface a coating of the aqueous nanoparticle ceramic agglomerate dispersion of claim 1, cooling the coating, and drying the coating to produce said recording medium.

8. The method according to claim 7 wherein said recording surface is a water absorbing paper.

9. The method according to claim 7 wherein said dispersion also contains a cationic polymer.
